(19) United States
(12) Patent Application Publication
(10) Pub. No.: US 2024/0166543 A1
(43) Pub. Date: May 23, 2024

(54) METHODS OF SEAWATER SOFTENING FOR DESALINATION AND MINERAL EXTRACTION

(71) Applicant: Qatar Foundation for Education, Science and Community Development, Doha (QA)

(72) Inventors: Abdelnasser Abdelkhalek M Aboukhlewa, Doha (QA); Ahmed Abotaleb, Doha (QA); Alessandro Sinopoli, Doha (QA)

(21) Appl. No.: 18/283,173

(22) PCT Filed: Mar. 25, 2022
(86) PCT No.: PCT/QA2022/050005

§ 371 Date: Sep. 20, 2023

Related U.S. Application Data
(60) Provisional application No. 63/166,566, filed on Mar. 26, 2021.

(51) Int. Cl. C02F 5/02; B01D 53/14; C02F 1/00; C02F 1/06; C02F 1/44; C02F 1/52; C02F 1/66; C02F 101/10; C02F 103/08

(52) U.S. Cl. CPC C02F 5/025; B01D 53/1418; B01D 53/1475; C02F 1/004; C02F 1/06; C02F 1/441; C02F 1/66; B01D 2252/1035; B01D 2257/302; B01D 2257/504; B01D 2258/012; B01D 2258/0283; C02F 2001/5218; C02F 2101/101; C02F 2103/08; C02F 2301/046; C02F 2303/10

(57) ABSTRACT

Disclosed are methods for seawater softening for the desalination plants (thermal and membrane) by using the carbon mineralization (CM) technique. Disclosed are several process flow diagrams in which the carbon mineralization is integrated at the upstream and/or downstream of the thermal and membrane desalination processes. By using these methods, the released CO2 from industrial factories, seawater feed minerals solutes shall be removed to improve the performance of the desalination plants. Most importantly, valuable products such as Ca/Mg carbonates and BaSO4, which are being used in building rocks, concrete, cement, paints, plastic, etc., can be produced.

### BACKGROUND

CO2 mineralization (CM) is a simple chemical process based on the reaction between CO2, in aqueous solution, and metal ions (typically Mg2+ and Ca2+) to form stable solid carbonates. This process is naturally used by mollusks to form seashells and recently it has attracted a big interest as efficient, scalable and sustainable technology for carbon capture. CM holds a huge potential with estimated 300 Mt of CO2 removed per year, and about 5 tons of CO2 removed for every ton of carbonate produced.

Since sea water or rejected brine are rich in Na, Ca, and Mg ions, it represents an ideal feedstock for CM. Numerous works have reported successful methods of combing CO2 and brine/sea water. Currently, the most efficient ways of managing these wastes, at industrial scale, are represented by the Calera and the Solvay process. The former involves the reaction at basic pH of flue gas, from coal plants/steel plants or natural gas plants, with brine to yield the so-called Calera cement. The latter process uses ammonia as a catalyst to aid the reaction of CO2 with Na+ from brine, for the production of sodium bicarbonate. Carbonate applications include but are not limited to construction materials, chemicals for pharmaceutical industry, refractory materials, therefore there is the possibility to generate a revenue out of them.

The mineralization process usually takes place in two stages; in the first one, a base (NaOH or amines) is added to the brine, inside the reactor, until the desired pH is reached and a white suspension starts forming. Next, CO2 microbubbles are injected into the suspension. At this stage, a white solid precipitates and it is collected by filtration, to yield the desired carbonate. The main reactions involved can be summarized as:

CO₂(g)+H₂O+2OH⁻→CO₃²⁻+2H₂O

CO₃²⁻+Ca²⁺→CaCO₃(s)

Potential sources of CO2 include: flue gas coming from the exhaust of diesel engines (˜0.270 kg CO2/kWh or ˜2.68 kgCO2/lDIESEL); flue gas from industrial plants, flue gas from desalination plants.

Upon treatment by mineralization, the spent water will be characterized by remarkable lower concentration of magnesium, calcium and potentially sodium ions, compared to starting solution. Therefore CM could represents a way to de-concentrate reject brines before disposal, in order to mitigate their harmful impact on the environment, or pretreat seawater before desalination process to minimize scale formation.

The main advantages of CM technology are represented by the possibility to operate at room temperature and atmospheric pressure, to yield a variety of added-value products, to add an efficient water sweetening step, to reduce carbon footprint and brine waste. However, it requires the use of an alkaline source and it is difficult to control the morphology of the final carbonates.

Various attempts to integrate CM process with desalination system, or to use brine and seawater as main feedstock for the formation of carbonates are known in the art:
Carbon dioxide adsorption and mineralization via seawater decalcification by bipolar membrane Electrodialysis system with a crystallizer by Zhao et al. used Bipolar Membrane Electrodialysis (BME) to precipitate metal ions. The use of bipolar membranes greatly reduces the effects of fouling, commonly encountered by other membranes. Pure carbon dioxide was absorbed in artificial seawater and it was found that over 90% of Ca and Mg ions could be recovered at ambient temperatures. Bipolar membranes are a special class of ion exchange membranes. They consist of two polymer layers, one allowing the passage of cations and the other only anions. It provides economic benefit over other ion exchange techniques as no side reactions take place and no gas removal required. The following parameters are used in Zhao-Raw material: Pure carbon dioxide (purity 99.99%); deionized water; the initial solution of each chamber was 0.01 mol/L HCl, 0.01 mol/L NaOH, 20 g/L NaNO3, artificial seawater. Product: over 90% of the Ca2+ and Mg2+ ions could be precipitated as MgCO3 and [MgCa(C03)2]. Process conditions: Ambient temperature. Technology/Reactor: Bipolar membrane Electrodialysis. Pros: effective in producing bases without oxygen and hydrogen production; removal of CaCO3 from freshwater is achievable. Cons: Require pretreatment to avoid scaling. Zhao, Y.; Wang, J.; Ji, Z.; Liu, J.; Guo, X.; Yuan, J., A novel technology of carbon dioxide adsorption and mineralization via seawater decalcification by bipolar membrane Electrodialysis system with a crystallizer. Chemical Engineering Journal 2020, 381, 122542.

CO2 Mineralization Using Brine Discharged from a Seawater Desalination Plant Brine by Bang et al. from a reverse osmosis plant was used in this work, since brine from desalination plants contains about 2 times more metal ions than seawater. The mineralization took place in two stages; in the first stage, NaOH was slowly added to the brine until the desired pH was reached and a white suspension formed. Next, in a jacket reactor with a circulated coolant, the CO2 microbubbles were injected into the suspension. This was done until the pH reached a value of 8. The products from filtration revealed that calcite, hydro magnesite, halite were successfully produced. The yield for hydro magnesite was 86% and 99% yield for calcite. The following parameters are used by Bang-Raw material: Brine (from RO), NaOH solution; Product: calcite, hydromagnesite, halite; Process conditions: ambient temp and pressure; Technology/Reactor: bubbly column, jacket reactor; Yield: Mg reacted with CO2 to form hydro magnesite with 86% yield. Most of the Ca formed calcite, with 99% yield. Pros: using brine instead of seawater means less pretreatment requirements. Bang, J.-H.; Yoo, Y.; Lee, S.-W.; Song, K.; Chae, S., CO2 Mineralization Using Brine Discharged from a Seawater Desalination Plant. Minerals 2017, 7 (11), 207.

A combined approach for the management of desalination reject brine and capture of CO2 by El Naas et al. used brine of various salinity along with CO2, both pure and mixed with methane, as raw material. A bubble column is used to inject gas from the bottom into the ammoniated brine solution. A vacuum pump was used to ensure through mixing as well as maintaining gas pressure inside the vessel. The effect of temperature on the removal of the Na+ ions was studied and it was found that 20° C. was the optimum temperature for maximum removal of ions. The following parameters are used by El-Naas-Raw material: Carbon dioxide was used either as a pure gas or a mixture of 10% CO2 in methane. The optimum NH3/NaCl ratio was 2 for synthetic brine solutions and 3 for actual reject brine. Brine samples with salinity ranging from 75,000 to 80,000 ppm. Ammonia solution containing 25 wt. % NH3, Product: NaHCO₃. Process Conditions: 20° C. and a reaction time of 2 h. Technology/Reactor: stainless steel bubble column reactor, semi-batch mode, for all other experiments, a copper coil was wound around the stainless steel reactor for good temperature control. All runs were carried out for a period of 120 min. Pros: Producing valuable products. Cons: using of ammonia solution, which is expensive, toxic and require long steps for regeneration. El-Naas, M. H.; Al-Marzouqi, A. H.; Chaalal, O., A combined approach for the management of desalination reject brine and capture of CO2. Desalination 2010, 251 (1), 70-74.

Design and sustainability analysis of a combined CO2 mineralization and desalination process, in 2018, by Jaewoo et al. used Electrodeionization (EDI) to produce NaOH from brine solution. The seawater undergoes pretreatment through ion exchange then it turned to brine. The NaOH then absorbs the flue gas from a cement plant as CO2 source, after it has been pretreated. The NaHCO₃ product is then precipitated in a crystallizer, followed by a decanter to separate the uncrystallized ions. Jaewoo et al. incorporated Electrodeionization along with reverse osmosis and ion-exchange as basic pretreatment techniques to further accomplish two aims: carbon mineralization to produce sodium bicarbonate, as well as produce fresh water from brackish water. They incorporated Electrodeionization and reverse osmosis in two integrations: forward and backward. In both integrations, the EDI unit feeds the CO2 mineralization unit and the RO produces the freshwater stream. The following parameters are used by Jaewoo-Raw material: brine (about 3.36 wt % NaCl solution) from the pretreatment goes into the EDI where electrochemical reaction takes place. Product: NaHCO₃. Technology/Reactor: Ion exchange, Electrodeionization, RO, CM reactor. Techno-economic: Process can generate an additional economic benefit of about 1 million US $/yr compared to the benchmark process.

In 2019, Jaewoo et al. came up with another integration scheme which replaced the seawater with brackish water. Since brackish water can be purified to yield fresh water, an addition RO step was introduced, and the rest remained the same. Keeping the plant lifetime, discount rate and other factors identical, carrying out techno-economic analysis, it was found that the scheme with seawater was much more economical than the one with brackish water and chloride ions. The ion exchange used with brackish water also focused on removing the carbonate ion for the purpose of not damaging the RO membrane. The overall purpose of ion exchange is to remove the unnecessary ions that lower the efficiencies of the downstream processes. Both schemes used reverse osmosis, however the brackish water process scheme uses RO to produce fresh water as well as to regenerate the ion-exchange. The seawater scheme simply produces fresh water, as well as concentrated brine which is used to produce high purity sodium chloride. The following parameters are used by Jaewoo-Feedstock: Flue gas from a cement kiln: CO2 (about 30 mol %), Brackish water. Final product: NaHCO₃ Type of desalination technology used: Ion Exchange, Electrodionisation. Oh, J.; Jung, D.; Oh, S. H.; Roh, K.; Chung, J.; Han, J.-I.; Lee, J. H., Design and sustainability analysis of a combined CO2 mineralization and desalination process. IFAC-PapersOnLine 2018, 51 (18), 85-90; Oh, J.; Jung, D.; Oh, S. H.; Roh, K.; Ga, S.; Lee, J. H., Design, simulation and feasibility study of a combined CO2 mineralization and brackish water desalination process. Journal of CO2 Utilization 2019, 34, 446-464.

Feasibility study of net CO2 sequestration using seawater desalination brine with profitable poly-production of commodities by Tsubuku et al. used a specific reaction pathway to separate the monovalent Na—K ions from the bivalent Mg—Ca ions in desalination brine, in order to make it usable for carbon mineralization. The temperature and pressure of desalination brine was controlled to promote the precipitation of CaSO4·2H2O. After evaporating 95% of the water content, temperature and pressure were further controlled to yield CaSO4·2H2O, NaCl and Na2SO4. Since only Mg ions were targeted for mineralization, the rest of the non-Mg ions were removed by HCl sparging. After that, anhydrous MgCl2 was added and high purity MgCl2 slurry was produced, which was directed towards the mineralization process. The scope of this pretreatment was to enhance the final mineralization product. The following parameters are used by Tsubuku-Feedstock: Concentrated brine to ˜10 times seawater concentration. Final product: Ca content is precipitated as high purity Ca2SO4˜2H2O (gypsum). 87% of the Na content as NaCl and Na2SO4 Roughly 22% of the resultant high purity MgCl2. Reaction conditions: temp and pressure controlled. Commercial application of final product: NaCl used for de-icing. Techno-economic: 0.22 Gtonne/y of NaCl of sufficient purity for industrial and de-icing use could be generated, providing ˜$1.77B/year in revenue. 0.10 Gtonne, CaSO4.2·H2O/y could currently be produced. The process would yield an additional ˜30.5 Gtonne, H2O/y with a value of $26-46B/y. Tsubuku, Yohei and Myers, Corey and Nakagaki, Takao, Feasibility Study of Net CO2 Sequestration Using Seawater Desalination Brine with Profitable Polyproduction of Commodities. 14th Greenhouse Gas Control Technologies Conference Melbourne 21-26 Oct. 2018 (GHGT-14).

Sequestering using mineralization was attempted by Glasser et al. Commercial CO2 gas was used along with sodium bicarbonate and sodium carbonate solution, MgCl2 as the feedstock. The reaction occurred in a batch reactor at ambient pressure and 25° C. The final product was obtained as Nesquehonite. The following parameters are used by Glasser-Feedstock: Commercial CO2 gas, sodium bicarbonate and sodium carbonate solution, MgCl2. Reaction conditions: constant stirring at room temperature (20 25° C.) and ambient pressure 1 atm) washing and filtering. Final product yield and selectivity: 75 80% Nesquehonite. Commercial application of final product: Applications such as panels and blocks, thermal insulation materials. Equipment used: Lab scale reactor for batch synthesis. Glasser, F. P.; Jauffret, G.; Morrison, J.; Galvez-Martos, J.-L.; Patterson, N.; Imbabi, M. S.-E., Sequestering CO2 by Mineralization into Useful Nesquehonite-Based Products. Frontiers in Energy Research 2016, 4 (3).

While CM is a simple chemical process, improvements of the process have been a challenge. Outstanding problems sought to be solved by the present disclosure are scale formation in the thermal desalination (MSF/MED/MD) process which affecting plant performance and elevated operational cost; scale formation in membrane desalination technologies (both MD and RO); carbon dioxide negative effect on the environment, when released into the atmosphere; environmentally impact of dispose the reject brine from the water desalination plants.

### SUMMARY

According to one non-limiting aspect of the present disclosure, a novel process of seawater/brine softening based on CO2 conversion for desalination and brine management (mineral extraction and zero liquid discharge) application includes the following:
Utilizing carbon mineralization as softening stage for saline water for removal of Ca/Mg ions as well as a portion of SO₄²⁻;
Utilizing water-soluble barium salts (e.g. BaCl2) to precipitate BaSO₄, and partially Ca/Mg SO4, and then conduct carbon mineralization reaction to precipitate Ca/Mg carbonate;
Conceptual design and process flow diagram of MED/MSF/MD Technology for high temperature;
Conceptual design and process flow diagram of MED/MSF/MD Technology for ZLD;
Conceptual design and process flow diagram of RO Technology for high process recovery; and
Conceptual design and process flow diagram of RO Technology for ZLD.

An advantage of one or more embodiments provided by the present disclosure is that the process provides an economical process for CO2 capture, sequestration, and utilization. This process is scale-adapted and can be designed to fit small, mid and large-scale plants. A further advantage is that this process can be adapted for different gas stream, for any brine source stream, and can be easily adapted to a current and new co-generation plant, where CO2 source is available from (flue gas) and fresh sea water/reject brine stream is coming from desalination plants.

In an embodiment, this process utilizes the divalent ions dissolved in saline water from desalination plant, to convert them into valuable products, rather than disposing them into the environment, and affect the marine life.

In a further embodiment, this process works for all the elements belonging to Group #2 of the periodic table and yields minerals as a final product.

An advantage of one or more embodiments is that the salinity of recirculation brine is reduced, compared to the feed dilution, therefore the scale formation and fouling factor are also reduced; overall heat transfer coefficient is increased and specific heat transfer area is reduced (i.e., decreases CAPEX). Reducing the scale will also reduce the frequency of ball cleaning, which helps to decrease the OPEX and the solution will reduce the fouling effect.

A further advantage of one or more embodiments is the decrease in friction for improvement in the pumping performance during operation. This allows for maintenance of the same salinity within the recovery section and hence, reduction of the make-up rate, NF pretreatment cost and evaporator CAPEX as well as reduction of the brine recirculation rate, which improves both pump capital cost and power requirements.

In an embodiment, the feed seawater has to be filtered to remove sediments, marine life, and other solids. An optimum amount of buffer solution (NaOH) is added to the sea water to elevate its alkalinity up to pH 10. Then, flue gas, potentially coming from power plants, is bubbled in the CM reactor to produce carbonates by precipitation (typically CaCO3, MgCO3, Na2CO3, BaCO3) and precipitate also portion of the sulfates.

In a further embodiment, the feed water is then separated into two streams: processed filtered saline water, and solid precipitates that are directed to washing, filtering and drying to produce valuable mineral product.

In yet a further embodiment for complete scale removal, it is proposed to precipitate first the sulfates through chemical precipitation, using BaCl2 to yield BaSO4, followed by filtration, washing, filtering and drying. The processed filtered saline water will go through carbon mineralization stage to precipitate carbonates (CaCO3, MgCO3, Na2CO3, BaCO3, etc.). Then, the saline water free from divalent ions is directed to desalination unit, either thermal-based or membrane-based, for producing fresh water and brine. Rejected brine from desalination unit is utilized in brine crystallizer to achieve zero liquid discharge.

Additional features and advantages are described herein, and will be apparent from the following Detailed Description and the figures.

### BRIEF DESCRIPTION OF THE FIGURES

FIG. 1 shows Scheme.1: Integrated Sea Water Softening—Thermal Desalination.

FIG. 2 shows Scheme.2: Integrated Sea Water Softening RO.

FIG. 3 shows Scheme.3: Integrated Sulphate Removal—Sea Water Softening—Thermal Desalination.

FIG. 4 shows Scheme.4: Integrated Sulphate Removal—Sea Water Softening RO.

FIG. 5 shows a setup of a CM reaction.

FIG. 6 shows an XRD analysis for precipitated ions.

FIG. 7 shows an XRD for stage-1, chemical precipitation to remove sulphates using BaCl2.

FIG. 8 shows an XRD for stage-2, carbon mineralization to remove rest of divalent ions.

FIG. 9 shows a Skillman Index.

FIG. 10 shows a Skillman Index at different RR and for different temperatures.

FIG. 11 shows an interface of VDS software for conventional MED of 15 MIGD.

FIG. 12 shows a VSP interface of 18 effects MED evaporator, TBT=65° C.

FIG. 13 shows specific energy consumption.

FIG. 14 shows an Umm Al-Houl RO desalination plant, Qatar.

FIG. 15 shows an interface of RO plant using treated feed seawater.

FIG. 16 shows a specific energy consumption.

### DETAILED DESCRIPTION

The present disclosure provides methods for seawater softening for the desalination plants (thermal and membrane) by using the carbon mineralization (CM) technique. The present disclosure provides several process flow diagrams in which, the carbon mineralization is integrated at the upstream and/or downstream of the thermal and membrane desalination processes.

The objective is to remove the most of divalent ions (mainly Ca2+ and Mg2+) that cause scale formation in the desalination plants. It also proposes to integrate CM with further mineralization step “chemical precipitation” using BaCl2, to remove SO4 anions.

By using these methods, the released CO2 from industrial factories, seawater feed minerals solutes shall be removed to improve the performance of the desalination plants. Most importantly, valuable products such as Ca/Mg carbonates and BaSO4, which are being used in building rocks, concrete, cement, paints, plastic, etc., can be produced.

Key commercial application includes desalination and ZLD application.

Key competitive advantages include the following: The techno-economic analysis revealed that the addition of SS stage could increase TBT up to 90° C. for MED and overall cost of water production is 25% lower than the conventional MED plant, in addition, to produce a valuable mineral, with net revenue of 1 $/ton of seawater feed. Increase the top brine temperature (TBT) of the thermal desalination plants in order to increase the water production rate and accordingly reduce the overall production cost of the desalination process (25% lower compared conventional thermal and RO plants); Decreasing the intake/cooling flow rate of the thermal desalination plant which decrease the thermal energy and environmental press in addition to decrease the capital cost of construction of the intake channel; Minimize maintenance and cleaning frequency in RO membrane desalination technology; Reduce the energy consumption of the RO plant by increasing the process recovery ratio; Increasing the process recovery of the RO plant will reduce the intake seawater channel and construction cost; Achieving zero liquid discharge in an economical way; To reduce CO2 emissions by convert carbon dioxide to a useful product through an economical sequestration process; A sustainable and cost-effective way for brine management/disposal instead of surface water discharge (SWD) technology, which is mostly used to dispose reject brine. SWD has a negative environmental effect on marine life, in addition, to be a costly process ($0.05/m3: $0.30/m3 of brine rejected).

There is no similar integration to improve the desalination plant. Most of the carbon mineralization just uses the brine of the desalination plant to capture the CO2.

Demand on fresh water is steadily increasing due to the rapid growth of population. Therefore, water desalination is steadily increasing as a reliable technology to produce fresh water in large scale especially in arid area. On the other hand, carbon dioxide (CO2) emission, considered as one of the main contributors to the greenhouse gases (GHGs), has a negative effect on the environment. In the large size desalination plant, the electricity and thermal energy are provided by power plant where the CO2 is released into the environment as exhaust-stream due to burning of the fuel as source of energy. Recently, there is a lot of interest towards capture of CO2 waste stream and either store it or convert it to valuable products (carbon capture, sequestration and utilization).

One of the major operational problems encountered in thermal-desalination plants is represented by scale formation. Water scale is a coating or precipitate deposited on surfaces that are in contact with hard water, it can be formed due to the composition of the makeup water, but mostly it is the result of further changes occurring during evaporation. Scale formation is mainly caused by crystallization of alkaline scales, e.g., CaCO3 and Mg(OH)2, and non-alkaline scale, e.g., CaSO4.

Scale formation is also responsible for membrane fouling, a process whereby a solution or a particle get deposited on a membrane surface, or in membrane pores, so that the membrane's performance decreases, this is typical of processes such as Reverse Osmosis (RO). It represents a major obstacle to the widespread use of this purification technology. Membrane fouling can also cause severe flux drop and affect the quality of the water produced. Severe fouling may require intense chemical cleaning or membrane replacement, increasing the operating costs of a treatment plant. There are various types of foulants: colloidal (clays, flocs), biological (bacteria, fungi), organic (oils, polyelectrolytes, humics) and scaling (mineral precipitates).

In order to reduce scale formation on the metallic surface or membrane surface, the feed saline water entering a desalination unit requires a softening process. This process would be applied to both the thermal-based techniques, such as MSF/MED, or membrane-based technique, such as RO. The purpose of the softening stage is to reduce the concentration of dissolved salts (solutes) in the feed water (solution), such as seawater, brackish water, or industrial brine solutions, so that it can be more effectively desalinated and higher percentage of fresh water can be recovered. It is a necessary step in order to reduce the salinity and hence reduce, or in some cases eliminate, to a certain extent scale-forming species. This will increase the efficiency of the process, allow relatively higher Top Brine Temperature (TBT) operation or enable separation technology for high concentration feed, reduce the pumping power in RO systems, increase membrane lifetime, reduce or eliminate the anti-scale dosing, reduce cleaning frequency and consequently reduce the overall system cost.

This invention proposes a method for softening the saline feed by using carbon mineralization (CM) technique to remove the most of divalent ions (mainly Ca2+ and Mg2+) that are the main cause for scale formation/membrane fouling. It also proposes to integrate CM with another purification step, specifically chemical precipitation of sulfate by using BaCl2, to permanently remove the rest of the divalent ions, in particular SO42− anions.

By using this process, the CO2 waste stream can be utilized instead of flaring to the environment, scale solutes can be removed and utilized rather than being rejected and, most importantly, valuable products such as Ca/Mg carbonates and BaSO4, which are being used in building rocks, concrete, cement, paints, plastic, etc., can be produced.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

### EXAMPLES

The following non-limiting examples are experimental examples supporting one or more embodiments provided by the present disclosure.

### Example 1: Scheme.1

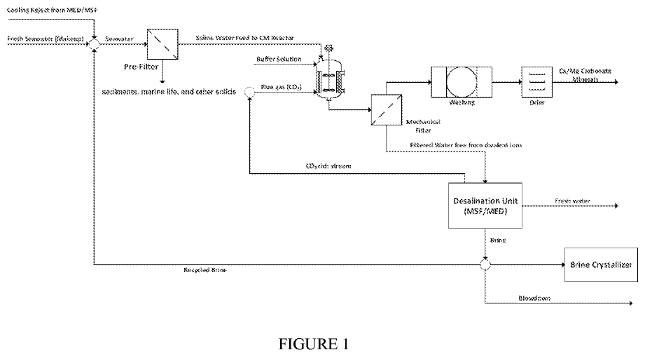

FIG. 1 shows that the feed water should be filtered first to remove sediments, marine life, and other solids.

An optimum amount of buffer solution (NaOH) is added to the sea water to elevate its alkalinity up to pH 10. Then, flue gas from mainly power plant, mixed with sucked non-condensable gases from thermal desalination unit, are bubbled in the CM reactor to produce carbonates by precipitation (e.g. CaCO3, MgCO3, Na2CO3, BaCO3, etc.) and precipitate also portion of the sulfates. Then the precipitate is washed, filtered and dried to yield valuable mineral product. The processed filtered saline water, free from most of divalent ions, is directed to thermal desalination unit for producing fresh water and brine. Rejected brine from desalination unit is partially recycled as feedstock, few portion as blow down to avoid system accumulation and the rest to be utilized in brine crystallizer to achieve zero liquid discharge. The crystallizer would be mechanical vapor compression system or through any precipitation methods, such as using BaCl2.

### Example 2: Scheme.2

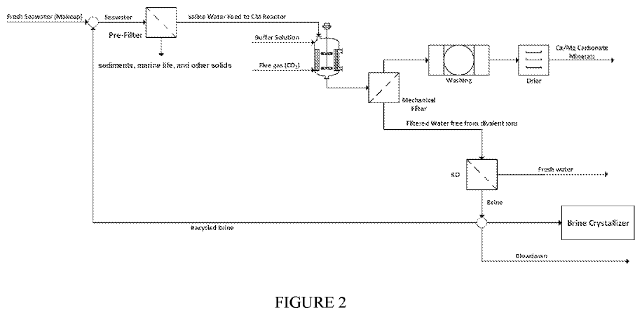

FIG. 2 shows that the feed water should be filtered first to remove sediments, marine life, and other solids.

An optimum amount of buffer solution (NaOH) is added to the sea water to elevate its alkalinity up to pH 10. Then, flue gas from mainly power plant is bubbled in the CM reactor to produce carbonates by precipitation (e.g. CaCO3, MgCO3, Na2CO3, BaCO3, etc.) and precipitate also portion of the sulfates. Then the precipitate is washed, filtered and dried to yield valuable mineral product. The processed filtered saline water, free from most of divalent ions, is directed to membrane-based desalination unit (Reverse Osmosis) for producing fresh water and brine. Rejected brine from desalination unit is partially recycled as feedstock, few portion as blow down to avoid system accumulation and the rest to be utilized in brine crystallizer to achieve zero liquid discharge. The crystallizer would be mechanical vapor compression system or through any precipitation methods, such as using BaCl2.

### Example 3: Scheme.3

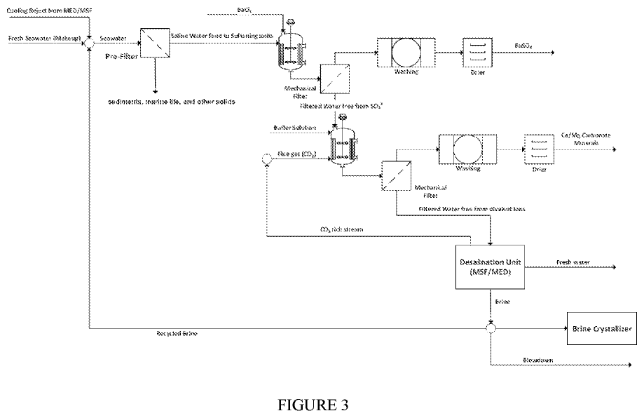

FIG. 3 shows that the feed water should be filtered first to remove sediments, marine life, and other solids.

In this scheme, it is proposed to precipitate first the sulfates through chemical precipitation, using BaCl2 to yield BaSO4, followed by filtration, washing, filtering and drying. The processed filtered saline water go through Carbon mineralization stage. An optimum amount of buffer solution (NaOH) is added to the sea water to elevate its alkalinity up to pH 10. Then, flue gas from mainly power plant, mixed with sucked noncondensable gases from thermal desalination unit, are bubbled in the CM reactor to produce carbonates by precipitation (e.g. CaCO3, MgCO3, Na2CO3, BaCO3, etc.). Then the precipitate is washed, filtered and dried to yield valuable mineral product. The processed filtered saline water, free from most of divalent ions, is directed to thermal desalination unit for producing fresh water and brine. Rejected brine from desalination unit is partially recycled as feedstock, few portion as blow down to avoid system accumulation and the rest to be utilized in brine crystallizer to achieve zero liquid discharge. The crystallizer would be mechanical vapor compression system or through any precipitation methods, such as using BaCl2.

### Example 4: Scheme. 4

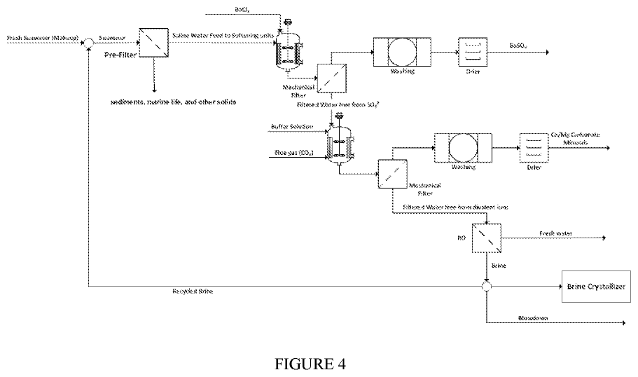

FIG. 4 shows that the feed water should be filtered first to remove sediments, marine life, and other solids. In this scheme, it is proposed to precipitate first the sulfates through chemical precipitation, using BaCl2 to yield BaSO4, followed by filtration, washing, filtering and drying. The processed filtered saline water go through Carbon mineralization stage. An optimum amount of buffer solution (NaOH) is added to the sea water to elevate its alkalinity up to pH 10. Then, flue gas from mainly power plant is bubbled in the CM reactor to produce carbonates by precipitation (e.g. CaCO3, MgCO3, Na2CO3, BaCO3, etc.). Then the precipitate is washed, filtered and dried to yield valuable mineral product. The processed filtered saline water, free from most of divalent ions, is directed to membrane-based desalination unit (Reverse Osmosis) for producing fresh water and brine. Rejected brine from desalination unit is partially recycled as feedstock, few portion as blow down to avoid system accumulation and the rest to be utilized in brine crystallizer to achieve zero liquid discharge. The crystallizer would be mechanical vapor compression system or through any precipitation methods, such as using BaCl2.

### Example 5: Proof of Concept—Carbon Mineralization for Saline Water Softening

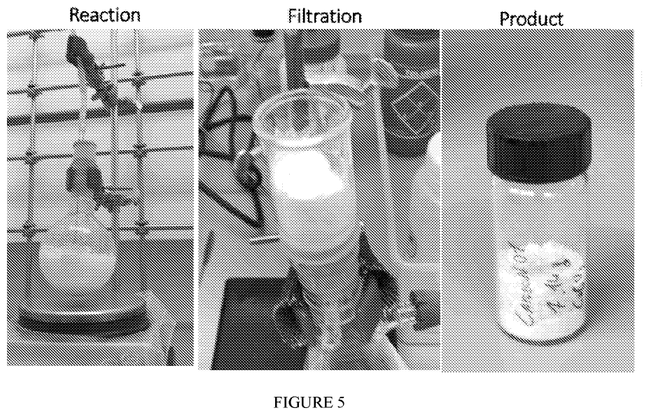

FIG. 5 shows a setup of a CM reaction.

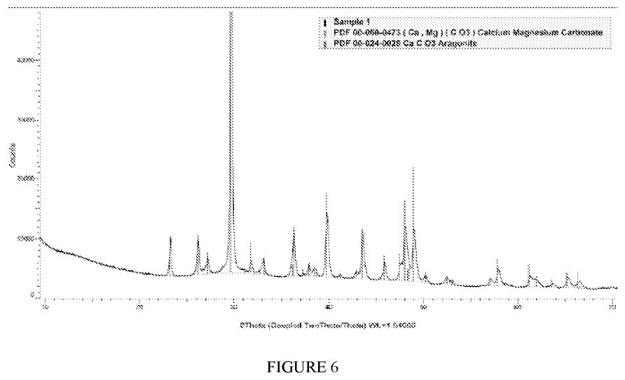

In a two-necks round bottom flask, 100 mL of artificial sea water was prepared based on the concentration of Mg2+, Ca2+ and SO4 2− ions in Ras-Laffan water (see Table.1), and kept under continuous stirring, at room temperature upon complete dissolution of solutes. Then, a buffer solution consists of NaOH was prepared to elevate the solution pH up to 10. pH was monitored by pH-meter. CO2 gas (purity 4N) was purged via needle into the solution with a pressure of 1 bar, at room temperature and under continuous stirring (600 rpm). After dosing CO2, the solution turned from clear to milky and a white fine precipitate started crushing out. After 30 minutes, the purging of CO2 was stopped. The solution was filtered under vacuum. The filtrate was washed with deionized water and left to dry at 80° C. overnight. The resulting white solid was characterized by XRD (see FIG. 6), which confirmed the formation of carbonates. The processed filtered solution was analyzed by inductively coupled plasma (ICP) to quantify the remaining ions in the solution (see Table.3).

TABLE 1
Sea water characteristics based on Ras Laffan area.

| Parameters | RAF |
|---|---|
| Magnesium (mg/L) | 1,615 |
| Sulphate (mg/L) | 3,200 |
| Sodium (mg/L) | 12,200 |
| Chloride (mg/L) | 24,800 |
| Calcium (mg/L) | 460 |

### Example 5: Proof of Concept—Integrated Chemical Precipitation-Carbon Mineralization for Saline Water Softening

In a two-necks round bottom flask, 100 mL of artificial sea water was prepared based on the concentration of Mg2+, Ca2+ and SO4 2− ions in Ras-Laffan water (see Table. 1), and kept under continuous stirring, at room temperature upon complete dissolution of solutes.

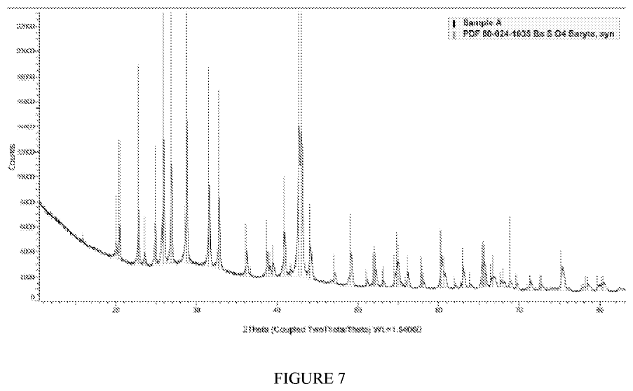

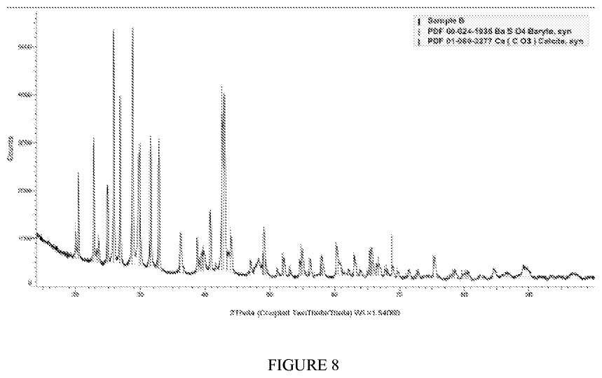

A stoichiometry amount of BaCl2, with respect to the concentration of sulphate, was added and immediately a white fine precipitate started crushing out. Upon BaSO4 precipitation, the solution was filtered under vacuum. The filtrate was washed with deionized water and left to dry in the oven overnight. The resulting white solid was characterized by XRD (see FIG. 7), which confirmed the formation of BaSO4. After that, the filtered solution was used again in a two necks round bottom flask to remove the rest of divalent ions mainly Ca2+/Mg2+ through carbon mineralization stage. Then, a buffer solution consists of NaOH was prepared to elevate the solution pH up to 10. pH was monitored by pH-meter. CO2 gas (purity 4N) was purged via needle into the solution with a pressure of 1 bar, at room temperature and under continuous stirring (600 rpm). After dosing CO2, the solution turned from clear to milky and a white fine precipitate started crushing out. After 30 minutes, the purging of CO2 was stopped. The solution was filtered under vacuum. The filtrate was washed with deionized water and left to dry at 80° C. overnight. The resulting white solid was characterized by XRD (see FIG. 8), which confirmed the formation of carbonates, together with further BaSO4 resulting from the previous precipitation step. The processed filtered solution was analyzed by inductively coupled plasma (ICP) to quantify the remaining ions in the solution (see Table. 3).

TABLE 2
Process Parameters and System Performance

| Item | Unit | Scheme. 1 | Scheme. 2 | Scheme. 3 | Scheme. 4 |
|---|---|---|---|---|---|
| Flue gas (5-15%) | kg-flue gas/m³ | | | | |
| CO₂ concentration | saline water | | | | |
| Buffer solution NaOH | Ton/Ton- | 0.00006 | | | |
| | Seawater | | | | |
| BaCl₂ | gm-BaCl₂/ | — | — | 1.47 | |
| | gm-SO₄²⁻ | | | | |

| | | | |
|---|---|---|---|
| Ca²⁺ Removal | % | >96 | >96 |
| Mg²⁺ Removal | % | 63 | 52.4 |
| SO₄²⁻ Removal | % | 59.8 | 94.7 |

TABLE 3
IC analysis for processed filtered solution
IC Analysis

| | pH | TDS | Unit | SO₄²⁻ | Mg²⁺ | Ca²⁺ | Cl⁻ | Na⁺ |
|---|---|---|---|---|---|---|---|---|
| Feed | 8.2 | 44,750 | mg/lit | 3,561 | 1,768 | 494 | 24,800 | 12,200 |
| Scheme 1&2 | 8.6 | 18,098 | | 1,432 | 655 | <20 | 10,150 | 33,550 |
| Removal | | | % | 59.8% | 63.0% | >96% | 59.1% | +175.0% |
| | pH | TDS | Unit | SO₄²⁻ | Mg²⁺ | Ca²⁺ | Cl⁻ | Na⁺ |
| Feed | 8.2 | 44,750 | mg/lit | 3,561 | 1,768 | 494 | 24,800 | 12,200 |
| Scheme 3&4 | 8.1 | 20,922 | | 187 | 842 | <20 | 11,700 | 25,826 |

| | | | | | | |
|---|---|---|---|---|---|---|
| Removal | % | 94.7% | 52.4% | >96% | 52.8% | +111.7% |

### Example 6: Proof of Concept—Skillman Index

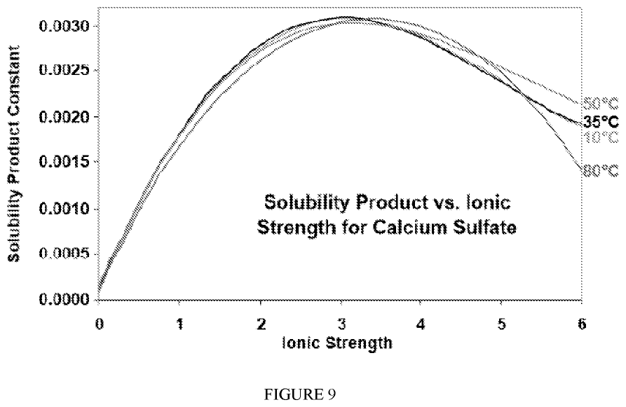

FIG. 9 shows a Skillman Index.

Calcium sulfate (gypsum) is two orders of magnitude more soluble than calcium carbonate. This means that the sulfate is much less likely to drop out of solution when both are present. The solubility of calcium sulfate can be a significant concern in water systems that contain large concentrations of both calcium and sulfate. This type of water might be present with oil-field brines. Skillman developed a simple sulfate solubility index for estimating the likelihood of calcium sulfate scaling in this type of application. It is of the form:

$$Skillman Index = \frac{{S}_{actual}}{{S}_{theoretical}} where {S}_{theoretical} = 1000 \times ( \sqrt{{x}^{2} + 4 {k}_{sp} )} - x )$$

Where the ratio will be for either the calcium or sulfate, whichever is the limiting species. The concentration will be in meq/L. To convert mg/L (ppm) of Ca2+ to meq/L divide ppm by 20. To convert mg/L (ppm) of SO4 2− to meq/L divide ppm by 48. The x in the equation is the excess common-ion concentration of the calcium and sulfate ions and can be calculated by:

x={2.5×|Ca²⁺|·1.04×[SO₄²⁻]}×10⁻³

Where the square brackets represent the concentrations of the species in mg/L. The ionic strength of the solution is needed for the calculations. It can be calculated from the measured TDS or as Skillman did, estimated its value from the concentrations of some of the main species in water by multiplying each by their respective conversion factors.

U=2.2×[Na⁺]+5.0×[Ca²⁺]+8.2×[Mg²⁺]+1.4+[Cl⁻]+2.1×[SO₄²⁻]+0.8×[HCO₃⁻]×10⁻⁵

To obtain that ksp value, Skillman developed a family of curves relating the calcium sulfate solubility product constant, ksp with the ionic strength. The ksp was obtained by the value corresponding to the ionic strength on the curve for the appropriate temperature. Later computerized versions did least-squares fits to the curves to approximate them with a polynomial.

When the value of the Skillman Index is greater than 1.0, it shows the water to be slightly on the scaling side with respect to calcium sulfate.

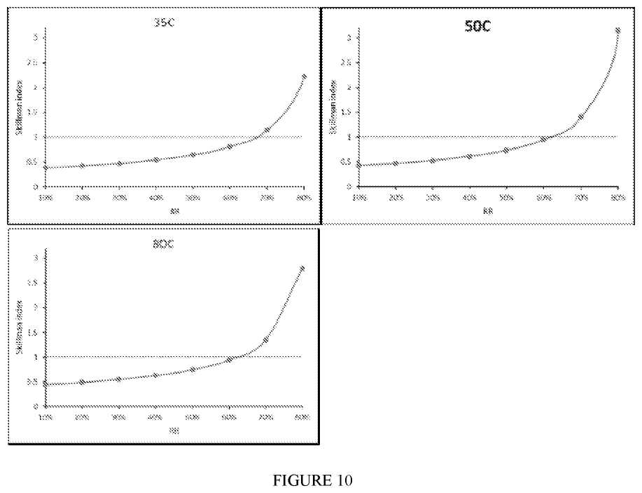

Based on the previous equations, the standard ionic concentrations in seawater (RAS plant) was used, together with the corresponding concentrations for brine at recovery ratio from 10% to 90%, to calculate the Skillman index. Recovery ratio calculations have been added in order to verify the maximum ratio before scale precipitation occurs (Skillman index >1). Kps for CaSO4 has been extrapolated from FIG. 10 at 50° C.

TABLE 4a
Recovery ratio (Once through stream)

| | Seawater | | | | | |
|---|---|---|---|---|---|---|
| | Feed | Recovery ratio ( Once through stream) | | | | |
| | Conc | 10% | 20% | 30% | 40% | 50% |
| Na⁺ | 12200 | 33555.56 | 15250 | 17428.57 | 20333.33 | 24400 |
| Ca²⁺ | 460 | 511.1111 | 575 | 657.1429 | 766.6667 | 920 |
| Mg²⁺ | 1615 | 1794.444 | 2018.75 | 2307.143 | 2691.667 | 3230 |
| Cl⁻ | 24800 | 27555.56 | 31000 | 35428.57 | 41333.33 | 49600 |
| SO₄²⁻ | 3200 | 3555.556 | 4000 | 4571.429 | 5333.333 | 6400 |
| HCO₃⁻ | 153 | 170 | 191.25 | 218.5714 | 255 | 306 |
| Ionic strength | 0.839454 | 0.932727 | 1.049318 | 1.19922 | 1.39909 | 1.678908 |
| CaSO₄ Kps | 0.001528 | 0.0001648 | 0.001788 | 0.001951 | 0.002142 | 0.002358 |
| Skillman | 0.387317 | 0.422246 | 0.466631 | 0.525328 | 0.607336 | 0.731484 |
| index | | | | | | |
| | | | Recovery ratio ( Once through stream) | | | |
| | | | 60% | 70% | 80% | 90% |
| | | Na⁺ | 30500 | 40666.67 | 61000 | 122000 |
| | | Ca²⁺ | 1150 | 1533.333 | 2300 | 4600 |
| | | Mg²⁺ | 4037.5 | 5383.333 | 8075 | 16150 |
| | | Cl⁻ | 62000 | 82666.67 | 124000 | 248000 |
| | | SO₄²⁻ | 8000 | 10666.67 | 16000 | 32000 |
| | | HCO₃⁻ | 382.5 | 510 | 765 | 1530 |
| | | Ionic strength | 2.098635 | 2.79818 | 4.19727 | 8.39454 |
| | | CaSO₄ Kps | 0.002582 | 0.002719 | 0.002324 | 0.000241 |
| | | Skillman | 0.944956 | 1.407689 | 3.146476 | 104.5185 |
| | | index | | | | |

Then, the concentration of Ca2+ and S4 2− respectively equal to 10 ppm was considered, in order to simulate the effect of removing a specific ion of the final Skillman index value. As reported in the table below, with values ranging from 0.38 to 0.94, upon reduction of calcium and sulfate to 10 ppm, an average Skillman index of 0.0095 and 0.0029 was obtained, respectively. Demonstrating the both removal have an almost identical effect on reducing the chances of scaling.

Table 4b: Recovery ratio (Once through stream)

TABLE 4b
Recovery ratio ( Once through stream)

| | | | Reduced | Reduced | | Reduced | Reduced |
|---|---|---|---|---|---|---|---|
| | | Reduced | Ca²⁺ | Ca²⁺ | Reduced | SO₂²⁻ | SO₂²⁻ |
| | sensor [symbol] | Ca²⁺ | RR 10% | RR 60% | SO₂²⁻ | RR 10% | RR 60% |
| | ppm | ppm | ppm | ppm | ppm | ppm | ppm |
| Na⁺ | 12200 | 12200 | 13555.56 | 50500 | 12200 | 13555.56 | 30500 |
| Ca²⁺ | 460 | 10 | 10 | 10 | 400 | 511.1111 | 1150 |
| Mg²⁺ | 1615 | 1615 | 1794.444 | 4037.5 | 1615 | 1764.444 | 4037.5 |
| Cl⁻ | 24800 | 24800 | 27556.56 | 62000 | 24800 | 27565.56 | 62000 |
| SO₄²⁻ | 3200 | 3200 | 3555.556 | 8000 | 10 | 10 | 10 |
| HCO₃⁻ | 153 | 153 | 170 | 382.5 | 153 | 170 | 382.5 |
| Ionic | 0.839454 | 0.016954 | 0.007671 | 2.041035 | 0.772464 | 0.85827 | 1.910845 |
| strength | | | | | | | |
| Skillman | 0.387317 | 0.009245 | 0.008676 | 0.010444 | 0.003047 | 0.003102 | 0.003759 |
| Index | | | | | | | |
| CaSO₄ Kps | 0.001528 | 0.001625 | 0.001617 | 0.002559 | 0.001558 | 0.001553 | 0.002507 |

[symbol]

indicates data missing or illegible when filed

### Example 7: Prototype Based Simulation of the MED Desalination

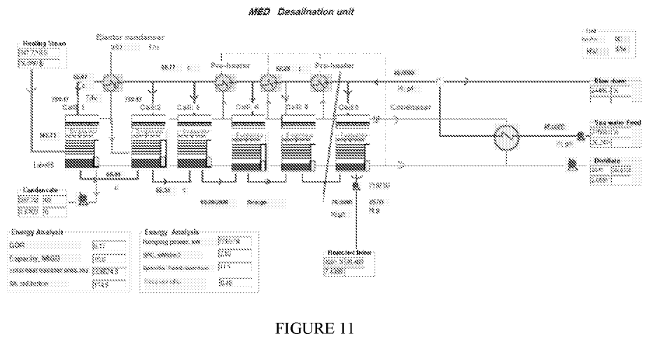

FIG. 11 shows an interface of VDS software for conventional MED of 15 MIGD.

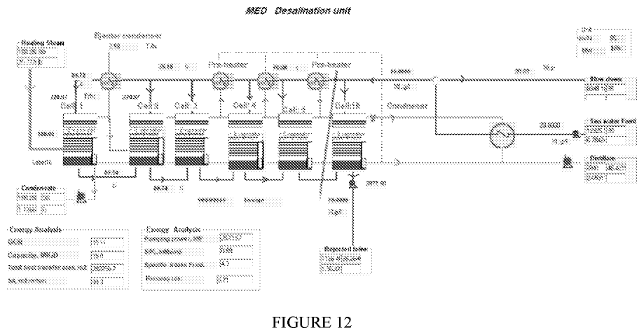

FIG. 12 shows a VSP Interface of 18 effects MED evaporator, TBT=65° C.

The previously developed and verified VSP software is used as a simulation tool to carry out process design calculations at different TBTs. The VSP is also utilized to size tube bundle, and then predict the scale deposit over the evaporator tubes. A process flow diagram of a typical operating medium size MED evaporator (15 MIGD) working at TBT=65° C. is used as a reference case. The process simulation is performed by specifying the heating steam operating conditions (pressure, temperature), the target capacity by evaporator (distillate rate per hour), top brine temperature (TBT), feed seawater conditions (temperature & salinity), blow down (temperature & salinity). Some design parameter such as the number of effects, tube length, diameters, material type are specified. Using VSP, all process stream characteristics are determined (mass, temperature, pressure). Also, the calculated GOR, the heat transfer surface area (number of tubes), the specific power consumption is calculated. Evaporator size, and internal dimensions are sized. Some of the technical limitations are taken into consideration during the design process in order to reduce the relevance thermal and pressure losses. Using the softening seawater feed with MED process either enables the increase of TBT greater than 65° C. The increase of the TBT enables to increasing the number of cells and accordingly reduce the energy consumption and reduce the heat transfer area.

A comparison between the high TBT MED and the traditional MED is illustrated in Table.5. For the same capacity and same operation and design parameters, the calculated GOR of the high TBT MED is 70% higher than that of the reference MED due to increase the TBT for the heat transfer area. The specific pumping power of high TBT MED is 54% lower than that of the reference MED due to lower cooling water flow also lower heating steam energy requirement. The specific intake flow rate of the high TBT is 57% lower than the conventional plant. The specific energy consumption of the high TBT MED with softening seawater feed is 24% lower than the conventional plant.

TABLE 5
Comparison between high TBT MED and conventional MED.

| | | MED | High | |
|---|---|---|---|---|
| | | (Ref.) | TBT MED | % diff. |
| 1 | Plant capacity, MIGD | 15 | 15 | — |
| 2 | TBT, ° C. | 6 [symbol] | 9 [symbol] | |
| 3 | Seawater feed temperature | 3 [symbol] | 3 [symbol] | |
| 3 | Feed salinity, g/l | 45 | 20 | — |
| 5 | Brine salinity, g/l | 70 | 70 | — |
| 5 | GOR | 8.2 | 15 | 82% |
| 6 | Specific heat transfer | 114 | 100 | −12% |
| | area, m²/(ton/hr) | | | |
| 7 | Specific power consumption, kWh/m³ | 2 | 0.9 | − [symbol] % |
| 9 | Process recovery ratio | 40% | 70% | 75% |
| 10 | Specific energy consumption kWh/m³ | 5.5 | 4 | −27% |

[symbol]

indicates data missing or illegible when filed

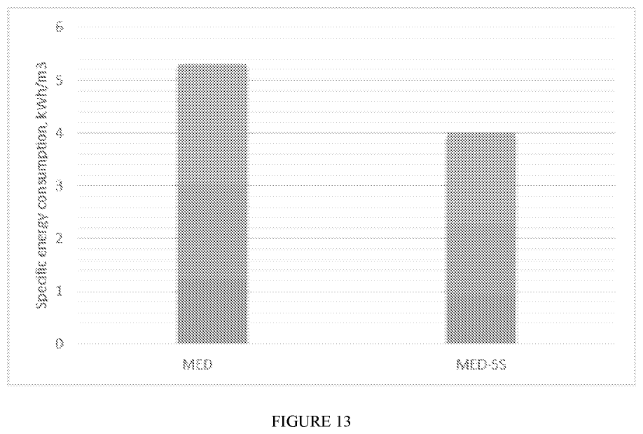

The specific energy consumption of the MED requires to calculate the mechanical energy equivalent of thermal energy (heating steam) to be added to the pumping power consumption. Using the VSP, the CCGT with MED power and desalination plant is solved to calculate the specific energy consumption. As shown in FIG. 13, the MED with SS has a specific energy consumption of 27% lower than the conventional MED using row seawater feed. The unit water cost of the MED with SS is 25% lower than the conventional MED.

TABLE 6
Techno-economic comparison between MED and MED-SS.

| | Cost analysis | MED | MED-SS | Difference |
|---|---|---|---|---|
| 1 | Interest rate | 0.07 | 0.07 | |
| 2 | Life span | 20.00 | 20.00 | |
| 3 | amortization | 0.094 | 0.094 | |
| 4 | $/year | 8,249,689.25 | 6,600,203.67 | −20% |
| 5 | availability | 0.95 | 0.95 | |
| 6 | S/hr | 991.31 | 793.10 | −20% |
| 7 | CAPEX, $/m3 | 0.34 | 0.28 | −18% |
| 8 | OPEX, $/m3 | 0.54 | 0.38 | −30% |
| 9 | water unit cost, $/m3 | 0.88 | 0.66 | −25% |

### Example 8: Prototype Based Simulation of the RO Desalination Plant

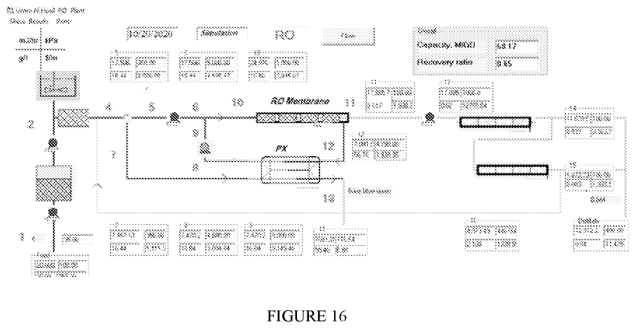

FIG. 16 shows specific energy consumption.

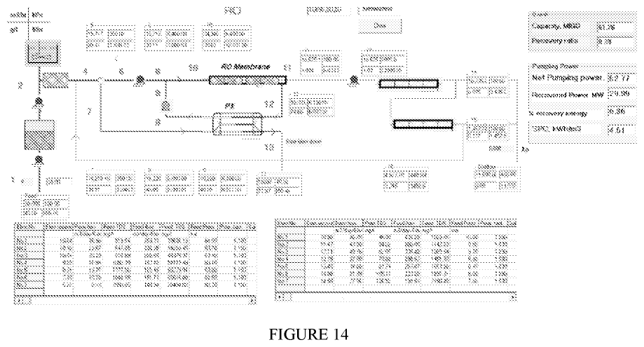

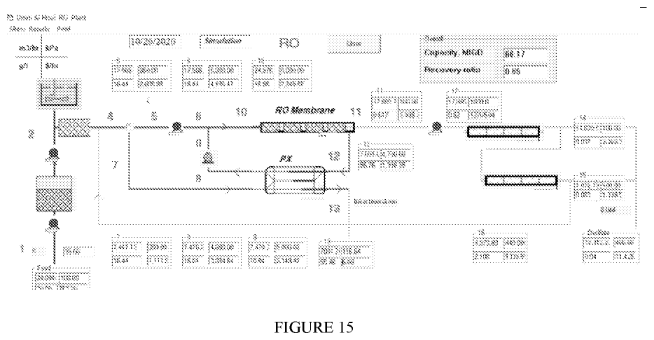

Reverse Osmosis desalination plant is effect desalination plant however it affected also with the seawater feed salinity and purity. FIG. 14 shows the VDS interface of the Umm Al Houl when feed with seawater of 45 g/l while FIG. 15 shows the interface of the same plant with treated seawater.

Table 7 shows the comparison between the RO plant when feed with seawater and treated seawater. The simulation results show due to treated sweater feed, the production increase 10% while the process recovery ratio increased by 70%. The specific power consumption decreased by 28% and the feed flow rate decreased by 40%.

TABLE 7
Comparison between high process recovery
RO and reference RO plant.

| | | RO | Softening | % |
|---|---|---|---|---|
| | | (Ref.) | seawater RO | diff. |
| 1 | Plant capacity, MIGD | 60 | 68 | 10% |
| 2 | Feed salinity, g/l | 45 | 20 | — |
| 3 | Feed temperature, ° C. | 35 | 35 | — |
| 4 | Brine salinity, g/l | 75 | 60 | −13% |
| 5 | Recovery ratio | 39% | 65% | 70% |
| 6 | Specific membrane area, m²/(ton/hr) | — | — | — |
| 7 | Specific power consumption, | 4.5 | 3.29 | −27% |
| | kWh/m³ | | | |
| 8 | Specific feed flow rate, ton/ton | 2.6 | 1.5 | −4 [symbol] % |

[symbol]

analysis

| | | RO | Softening | |
|---|---|---|---|---|
| | | (Ref.) | seawater RO | |
| 1 | Chemical cost $/h | 599 | 410 | − [symbol] 2% |
| 2 | Electrical cost $/h | 2043 | 1627 | −20% |
| 3 | Blowdown cost $/h | 22 | 7 | −6 [symbol] % |
| 4 | Permeate cost $/h | 11,565 | 11,425 | −1% |
| 5 | Unit water cost $/m³ | 0.98 | 0.88 | −10% |

[symbol]

indicates data missing or illegible when filed

As reported in Table 7, using softening seawater technique will reduce the specific energy consumption by 27%

### Example 9: Commercial Scale Plants for Carbonate

Examples of companies that are operating commercial-scale projects of CO2 mineralization include Skyonic Corporation and Calera Corporation in the US, and Twence in the Netherlands. The Skymine project of Skyonic has been supported by the US Department of Energy since 2010, for developing a technology to chemically react flue gas with caustic soda obtained from the electrolysis of brine to produce chemicals such as sodium bicarbonate (NaHCO₃). In San Antonio, TX, a plant utilizing CO2 emitted from a cement factory to produce sodium bicarbonate, hydrogen chloride (HCl), bleach (NaOCl) and chlorine(Cl2), has been in operation since October 2014. The plant is capable of utilizing approximately 75,000 tons of CO2 per year to produce 140,000 tons of sodium bicarbonate per year. Alkalinity Based on Low Energy (ABLE)” to react calcium and magnesium cations obtained from caustic soda and sea water with CO2 in flue gas to produce calcium carbonate and magnesium carbonate, respectively. Presently, a pilot plant has been constructed and is in operation in California, where CO2 from the Dynegy Moss Landing Power Plant (generation capacity: 1.5 GW) is utilized to produce supplementary cement materials (5 tons/day). Twence, from the Netherlands, has developed a plant capable of utilizing CO2 and sodium carbonate produced by waste-to-energy plants to produce sodium bicarbonate, which in turn is utilized to remove SOx/HCl in flue gas. The plant is capable of utilizing approximately 2000 tons of CO2 per year to produce 8000 tons of sodium bicarbonate per year.

### Example 10: Design Basis and Techno-Economics for Commercial Scale Plants

The calculation basis based on commercial plant to possess an annual capacity of approximately 5000 tons of Ca/Mg Carbonate production. The provision of connecting duct from the stack to the CM has been considered. Piping/Ducting cost are already considered in techno comic analysis. Usually flue gas released at 57° C. (Air cooled condenser design temp). A duct from incinerator stack to CM reactor will be used with the same temperature without cooling/pre-treatment. Key performance data based on a benchscale CO2 mineralization process are used for the technical feasibility analysis of this work. The below table reflects the main reactor design parameters:

TABLE 8
Capex.

| Specifications | Bench Scale | | Commercial Scale |
|---|---|---|---|
| Reactor Height/Diameter (m) | 1.6/0.08 | | 11.5/0.6 |
| Liq flow rate | 8.3 | (g/min) | 2.7 Ton/Ton-carbonate |
| CO₂ flow | 2 | (kg/day) | 0.6 Ton-CO₂/ |
| | | | Ton-carbonate |

| | | |
|---|---|---|
| Flooding factor: Top/Bottom (%) | 0.8/0.7 | 55.1/52.4 |
| Gas velocity (m/sec) | 0.02 | 0.13 |
| Material of reactor | Glass/Acryl | SS-304 |

TABLE 9
Assumed parameter values for the economic evaluation: —

| Specification | Value |
|---|---|
| Plant Lifetime (years) | 20 |
| Equipment Salvage value | 0 |
| Construction period (years) | 2 |
| Discount rate (%) | 5.5 |

TABLE 10
Unit price cost per feed:

| | SW | CO₂ |
|---|---|---|
| Equipment | $/Ton | $/Ton |
| Oven | 31.67 | 6.33 |
| Mechanical Filter | 140.00 | 28.00 |
| Storage Tanks | 91.67 | 18.33 |
| Pumps | 108.33 | 21.67 |
| Reactor | 298.33 | 59.67 |

TABLE 11
Total Discounted Capex for each scheme: —

| | | | | |
|---|---|---|---|---|
| Scheme No. | Scheme. 1 | Scheme. 2 | Scheme. 3 | Scheme. 4 |

| | | |
|---|---|---|
| Total Cost | 0.076 | 0.1530 |
| ($/Ton-Seawater Feed) | | |

Opex—Material price: BaCl2 dosing: $225/Ton, NaOH dosing: $200/Ton; Operating cost: BaCl2 dosing: 1.47 gm-BaCl2/gm-SO42−; NaOH dosing: 0.06 gm/m3 water

TABLE 12
Opex
OPEX

| ITEM | | BaCl₂ | NaOH |
|---|---|---|---|
| Unit Price | $/Ton | 225 | 200 |
| Dosage | Ton/Ton SW | 0.005235 | 0.00006 |
| Cost | $/Ton | 1.18 | 0.01 |

TABLE 13
Total Opex per Scheme: —

| | | | | |
|---|---|---|---|---|
| Scheme No. | Scheme. 1 | Scheme. 2 | Scheme. 3 | Scheme. 4 |

| | | |
|---|---|---|
| Total Cost | 0.012 | 1.1898 |
| ($/Ton-Seawater Feed) | | |

TABLE 14
Total Capex and Opex per scheme:

| | | | | |
|---|---|---|---|---|
| Scheme No. | Scheme. 1 | Scheme. 2 | Scheme. 3 | Scheme. 4 |

| | | |
|---|---|---|
| Total Cost | 0.088 | 1.3428 |
| ($/Ton-Seawater Feed) | | |

TABLE 15
Selling Cost. Total selling cost per scheme w.r.t mineral
extraction and based on Ras-laffan seawater characteristics:

| Scheme | Scheme, 1 & Scheme, 2 | | | Scheme, 3 & Scheme, 4 | | |
|---|---|---|---|---|---|---|
| Item | CaCO₃ | MgCO₃ | BaSO₄ | CaCO₃ | MgCO₃ | BaSO₄ |
| Precipitated | 494 | 1113 | 2129 | 494 | 926 | 3374 |
| product mg/lit | | | | | | |
| Ton-Product/ | 0.000494 | 0.001113 | 0.002129 | 0.000494 | 0.000926 | 0.003374 |
| Ton-SW | | | | | | |
| Unit Price | 170 | 350 | 300 | 170 | 350 | 300 |
| ($/Ton-Product) | | | | | | |
| Selling Price | 0.08398 | 0.38955 | 0.6387 | 0.08398 | 0.3241 | 1.0122 |
| ($/Ton-SW) | | | | | | |
| Total Selling Price | 1.11 | | | 1.42 | | |
| (S/Ton-SW) | | | | | | |

TABLE 16
Net Revenue from Seawater Softening
w.r.t mineral extraction only.

| | | | | |
|---|---|---|---|---|
| Scheme No. | Scheme. 1 | Scheme. 2 | Scheme. 3 | Scheme. 4 |

| | | |
|---|---|---|
| Total Cost | 1.0237 | 0.0775 |
| ($/Ton-Seawater Feed) | | |

1. A method of sea water softening comprising:
adding buffer solution (NaOH) to sea water to elevate its alkalinity up to pH 10,
mixing flue gas with sucked non-condensable gases from thermal desalination unit,
bubbling in a reactor to produce carbonates and sulfates by precipitation,
washing the precipitate, and
filtering and drying the precipitate to yield valuable mineral product,
wherein processed filtered saline water, free from most of divalent ions, is directed to a thermal desalination unit for producing fresh water and brine,
wherein rejected brine from the desalination unit is partially recycled as feedstock, and at least a portion is blow down and at least a portion is utilized in brine crystallizer to achieve zero liquid discharge.

2. The method of claim 1, wherein the carbonates produced are at least one of CaCO3, MgCO3, Na2CO3, BaCO3.

3. The method of claim 1, the crystallizer is a mechanical vapor compression system.

4. The method of claim 1, wherein the crystallizer is BaCl2.

5. The method of claim 1, wherein the first step is precipitating the sulfates through chemical precipitation.

6. A method of sea water softening comprising:
adding buffer solution (NaOH) to sea water to elevate its alkalinity up to pH 10,
mixing flue gas with sucked non-condensable gases from thermal desalination unit,
bubbling in a reactor to produce carbonates and sulfates by precipitation,
washing the precipitate, and
filtering and drying the precipitate to yield valuable mineral product,
wherein processed filtered saline water, free from most of divalent ions, is directed to membrane-based desalination unit (Reverse Osmosis) for producing fresh water and brine,
wherein the rejected brine from desalination unit is partially recycled as feedstock, and at least a portion is blow down and at least a portion is utilized in brine crystallizer to achieve zero liquid discharge.

7. The method of claim 6, wherein the carbonates produced are at least one of CaCO3, MgCO3, Na2CO3, BaCO3.

8. The method of claim 6, wherein the crystallizer is a mechanical vapor compression system.

9. The method of claim 6, wherein the crystallizer is BaCl2.

10. The method of claim 6, wherein the feed water should be filtered first to remove sediments, marine life, and solids.

11. The method of claim 1, wherein the method is performed at a top brine temperature at or above 65 degrees Celsius.

12. The method of claim 1, wherein the flue gas originates from at least one of exhaust of diesel engines, industrial plants, and desalination plants.

13. The method of claim 6, wherein the flue gas originates from at least one of exhaust of diesel engines, industrial plants, and desalination plants.

14. The method of claim 1, wherein the sulfate precipitated is BaSO4.

15. The method of claim 6, wherein the sulfate precipitated is BaSO4.

16. The method of claim 6, wherein a reduction of specific energy consumption equal to or greater than 27%.
